(19) United States
(12) Patent Application Publication
(10) Pub. No.: US 2024/0410580 A1
(43) Pub. Date: Dec. 12, 2024

(54) METHOD FOR MODEL-PREDICTIVE CONTROL OF A FUEL-AIR MIXTURE OF A SYSTEM, AND AN ASSOCIATED SYSTEM

(71) Applicant: ebm-papst Landshut GmbH, Landshut (DE)

(72) Inventors: Andreas KERSCHREITER, Eching (DE); Bernhard SIMON, München (DE)

(21) Appl. No.: 18/702,942

(22) PCT Filed: Oct. 12, 2022
(86) PCT No.: PCT/EP2022/078352

§ 371 Date: Apr. 19, 2024

(30) Foreign Application Priority Data
Oct. 20, 2021 (DE) 10 2021 127 223.8

(51) Int. Cl. F23N 5/18; F23N 1/00; G05D 7/06; G06N 5/022

(52) U.S. Cl. CPC F23N 5/187; F23N 1/002; G05D 7/0623; G06N 5/022; F23N 2235/16; F23N 2900/05181

(57) ABSTRACT

A method for controlling a fuel-air mixture of a system with a manipulated variable for controlling an actuator (2) of the system in a first method phase for identification of the system behavior using a standard controller, in order to adjust the actual value on average to a target value. A profile of the actual value and a profile of the manipulated variable are recorded during the first method phase for identification of the system behavior, and from these the gain factor depending on the manipulated variable and the dead time are determined. After the determination of the dead time and the gain factor in a second method phase for model-predictive adaptive control of the system, the manipulated variable is determined using a model-based controller that has a Smith predictor and takes account of the gain factor and the dead time in order to adjust the actual value to the target value. Thus, in the second method phase, the manipulated variable has to be altered less frequently and less significantly by comparison with the first method phase.

The disclosure relates to a method for model-predictive control of a fuel-air mixture of a system and to an associated system, which is preferably a gas boiler.

In devices known in the prior art for controlling a fuel-air mixture in a heating boiler, which, in the case of heating boilers configured as gas boilers, is usually a gas-air mixture, a differential pressure sensor is usually provided which determines the pressure difference or the differential pressure between a pressure at a measuring point upstream of a main flow restrictor of the gas boiler and a (reference) pressure at a reference point.

Furthermore, a digital controller is usually configured to adjust an actuator on the basis of the measured pressure such that a desired target value of the pressure is reached or maintained as far as possible without control deviation and without an overshoot.

The actuator used is, for example, a valve which may be referred to as a control or gas valve and the valve position of which is adjustable via a stepper motor, so that the flow through the control valve is gradually controllable by the stepper motor.

Thus, to maintain the measured pressure as an actual value in the range of the target value, the prior-art actuator often keeps being driven again and again in rapid succession and over a long period of time, so that the actuator may be subject to considerable wear. Due to the wear, correspondingly regular maintenance and, if required, replacement of the actuator and/or the components of the actuator are necessary.

Therefore, the object of the disclosure is to overcome the aforementioned disadvantages and to provide a method for controlling a fuel-air mixture by means of which the service life of the actuator can be increased.

The disclosure therefore proposes a method for controlling a fuel-air mixture of a system, wherein this system is in particular a heating boiler and preferably a gas boiler. The system has mixing means for mixing a fuel with air to form the fuel-air mixture, an actuator arranged upstream of the mixer in the flow direction of the fuel, which is driven by a manipulated variable, for controlling a fuel mass flow of the fuel flowing into the mixer, and a differential pressure sensor for recording a differential pressure between a pressure of the fuel relative to the flow direction of the fuel upstream of the mixer and downstream of the actuator relative to a reference pressure in the flow direction of the air upstream of the mixer as an actual value. The differential pressure can also be referred to as an offset pressure or a pressure difference. Further, the system preferably comprises a main flow restrictor which is fluidically arranged between the actuator and the mixer, preferably wherein the differential pressure sensor records the differential pressure between a pressure of the fuel upstream of the main flow restrictor and the reference pressure. The actual value recorded by the differential pressure sensor changes systemically when a change in the manipulated variable causes a change in position of the actuator, which correspondingly leads to a change in the mass flow of the fuel flowing into the mixer, not immediately but after a dead time and with a gain factor which depends on the manipulated variable causing the change. Here, a change in position is understood to mean in particular a change in a flow position or a change in a mass flow through the actuator. Accordingly, the system behavior in the event of a change in the manipulated variable or a change in position of the actuator is describable by means of the dead time and the gain factor. According to the method of the disclosure, in a first method phase for identification of the system behavior it is provided that the manipulated variable for driving the actuator is determined using a standard controller, in order to adjust the actual value on average to a target value. In this case, standard controllers are understood to be linear controllers in particular and, more particularly, P, I, PI, PD and PID controllers. Due to each of the dead time and the gain factor, in particular during the first method phase, the manipulated variable and the actual value may oscillate around the target value with an amplitude and a frequency. A profile of the actual value and a profile of the manipulated variable over time are recorded during the first method phase for identification of the system behavior, and from these the gain factor is determined depending on the manipulated variable and the dead time. After the determination of the dead time and the gain factor in the first method phase, the manipulated variable is determined in a second method phase for model-predictive adaptive control of the system using a model-based controller which in particular has a Smith predictor. The model-based controller takes account of the previously determined gain factor and dead time, which is preferably incorporated by the Smith predictor when determining the manipulated variable. As such, the model-based controller is configured to adjust the actual value to the target value such that, in the second method phase, the manipulated variable has to be altered less frequently and less significantly by comparison with the first method phase.

By identifying the system behavior determined by the dead time and the gain factor in the first method phase and taking account of the system behavior in the second method phase, the actuator has to be driven correspondingly less frequently and, when driven, less significantly in the second process phase than in the first method phase and than with conventional controls or controls exclusively based on standard controllers, so that the wear of the actuator is reduced with the method according to the disclosure.

With the proposed method for model-predictive control, a robust and at the same time high-performance control of the differential pressure is possible, wherein by appropriate consideration of a change in system behavior, it is also possible to speak of adaptive and self-learning control.

The gain of the system depends on a number of factors and can therefore not be predicted or can be predicted only with difficulty. As an example, the transfer function of the system describing a gain may be influenced by the heating output of the heating boiler or the position of the stepper motor or of the valve, the type of gas, the gas supply pressure and/or by the control valve or its valve characteristic. Nevertheless, the gain may be determined comparatively easily if, upon a change of the manipulated variable as an input, the measured value of the differential pressure sensor is observed as an output.

In particular, the dead time in the system is dominated by delays in data processing of the controller or at the control and by delays in data processing of the differential pressure sensor. Delays or dead times with respect to fluid-mechanical processes are negligible in comparison. As such, the resulting dead time can be regarded as substantially constant.

To ensure that a change in the system behavior is also recognized and taken account of in the second method phase, according to an advantageous development, it is provided that during the second method phase a deviation of the actual value from the target value is determined and, if the deviation and/or an average value of the deviation exceeds a predetermined limit value, the dead time and the gain factor are determined according to the first method phase.

Similarly, to be able to detect and take account of a change in system behavior during the second method phase, a further embodiment provides that, during the second method phase, a profile of the manipulated variable (over time) is recorded and a number and level of manipulated variable changes are determined. If the number and/or the level of the manipulated variable changes exceed a respective predetermined limit value, the dead time and the gain factor are newly determined in accordance with the first method phase.

It may be provided that the method remains in the first method phase for a predetermined time before transitioning to the second method phase.

Alternatively or additionally, it may also be provided that in the first method phase a predetermined manipulated variable change occurs according to a predetermined time profile and/or the system configured as a heating boiler runs through a specific heating output curve to thereby be able to determine the system behavior in a predetermined manner.

According to an advantageous development, the dead time may be determined from a delay between a change in the manipulated variable and a change in the actual value caused by the change in the manipulated variable.

The gain in the system may be determined with little numerical effort from the signal profiles (actual value of the pressure or of the pressure difference or manipulated variable) of the oscillating controller in the first method phase.

Since the amplitudes of these signals are comparatively low for most systems, a gain determined in this way may be regarded as representative of the system.

Preferably, the gain factor and/or the dead time is/are determined by a Wiener filter. As such, the Wiener filter is configured to determine the gain factor and/or the dead time using the manipulated variable and the actual value.

In particular when using a simplified digital Wiener filter, the gain results from the ratio of cross-correlation and auto-correlation of the signals over time. In this case, observation over a period of 2 to 3 seconds is sufficient. The dead time in the system may also be determined or validated from the cross-correlation of the data.

The model-based controller, which is utilized in the second method phase for determining the manipulated variable, preferably comprises the Smith predictor and a standard controller. As such, the manipulated variable is determined by superimposing the Smith predictor with the standard controller, so that the dead time is compensated by the Smith predictor and the gain factor is compensated by the standard controller.

A further aspect of the invention relates to a system which is in particular a gas boiler. The system has mixing means for mixing a fuel with air to form the fuel-air mixture, an actuator arranged upstream of the mixing means in the flow direction of the fuel, which is driven by a manipulated variable, for controlling a fuel mass flow of the fuel flowing into the mixer, and a differential pressure sensor for recording a differential pressure between a pressure of the fuel relative to the flow direction of the fuel upstream of the mixer and downstream of the actuator relative to a reference pressure in the flow direction of the air upstream of the mixer as an actual value. Further, the system preferably comprises a main flow restrictor which is fluidically arranged between the actuator and the mixer, preferably wherein the differential pressure sensor records the differential pressure between a pressure of the fuel upstream of the main flow restrictor and the reference pressure. It is further provided that the system has a control which is signally connected to the actuator and the differential pressure sensor and is configured to perform a method according to the disclosure.

According to an advantageous development of the system, the actuator is a control valve with a stepper motor, by means of which the mass flow through the control valve is adjustable. Furthermore, the manipulated variable is a number of steps of the stepper motor or a value determining the number of steps of the stepper motor.

Preferably, the target value is a predetermined value and is in particular 0 Pa.

The features disclosed above can be used in any combination, as far as this is technically feasible and they do not contradict each other.

Other advantageous developments of the disclosure are characterized in the dependent claims or are presented in detail below along with the description of the preferred embodiment of the disclosure with reference to the figure. In the drawings:

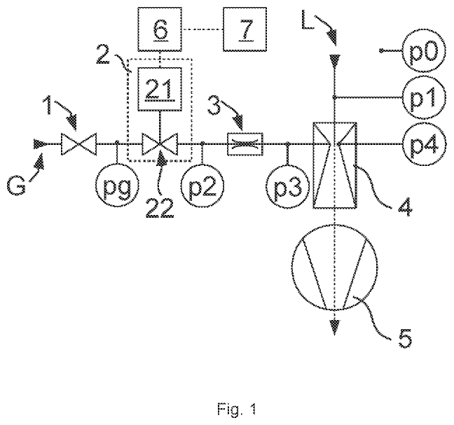

FIG. 1 is an exemplary schematic diagram of a gas boiler.

FIG. 1 schematically shows a part or a section of a gas boiler, wherein a Venturi mixer is shown as a mixer 4 where air is aspirated by a blower 5 through an air inlet L from the environment with an air pressure p0. In the mixer 4, the incoming air and a fuel (gas) flowing in through fuel supply G are mixed to form a fuel-air mixture.

As such, the fuel flowing in from fuel supply G, which is in particular a gas, flows through a safety valve 1, an actuator 2 configured as a control valve and main flow restrictor 3. Safety valve 1 preferably has a pass-through and a blocking position in which the flow of fuel through safety valve 1 is blocked. Actuator 2 is configured to control the volume or mass flow of the fuel, so that the fuel flow through actuator 2 to the mixer 4 is adjustable. Thus, the mixing ratio of the fuel-air mixture is adjustable by adjusting or controlling actuator 2. For this purpose, actuator 2 has a valve 22, the flow position of which is changeable or adjustable by a stepper motor 21, wherein the stepper motor 21 is driven by a control 6 using a manipulated variable.

Furthermore, at least one differential pressure sensor 7 is provided, which is configured to determine the differential pressure between the pressure p2 of the fuel upstream of main flow restrictor 3 and downstream of actuator 2 and a reference pressure, preferably wherein the reference pressure is ambient pressure p0 or a pressure p1 of the air in an air-conducting feed line to the mixer 4. For this purpose, differential pressure sensor 7 can, for example, have a respective pressure sensor or pressure transducer for recording a respective pressure p0, p1, p2. Further, additional pressure sensors may be provided for recording the further pressures pg, p3 and p4, which can serve as reference pressure sensors for recording a reference pressure or for plausibility checking of pressures p0, p1, p2. Differential pressure sensor 7 is signally connected to the control 6.

The fuel-air mixture is conveyed by blower 5 to a burner (not shown) of the gas boiler, where the fuel-air mixture is combusted.

According to the method, in a first method phase, it is provided, by way of example, that a controller implemented at the control 6 controls the differential pressure determined by differential pressure sensor 7 between pressure p2 of the fuel upstream of main flow restrictor 3 and a reference pressure p1 as an actual value on average to a desired target value (in particular 0 Pa) by driving actuator 2. As the system is dominated by dead times, the closed-loop control circuit, having the manipulated variable generated by the controller for driving stepper motor 21 as an input variable and the differential pressure determined by differential pressure sensor 7 as an output variable, exhibits a behavior of limit stability. Thus, the differential pressure as the actual value oscillates with an amplitude and frequency around the target value, wherein the mean control deviation is approximately 0. This behavior of limit stability may be utilized to identify the system or the system behavior. The system behavior is characterized by the dead time and by a gain depending on a position of actuator 2, which are determined accordingly.

As soon as the system is identified, i.e., the dead time and the gain are determined depending on the position of actuator 2, the control may be adapted in a second method phase. For this purpose, it is provided for the controller used in the first method phase and implemented on the control 6 to be expanded by a Smith predictor or for the Smith predictor to be activated. Alternatively, a further controller, for example implemented on the control 6, may also be activated, which takes over control in the second method phase and also comprises a Smith predictor.

In the second method phase, control of actuator 2 or the determination of the manipulated variable is accomplished by superimposing a standard controller (such as, for example, PI or PID) and the Smith predictor, the dead time being compensated by the Smith predictor and the gain factor being compensated by the standard controller. A controller superimposed on a standard controller and a Smith predictor can also be referred to as a Smith controller and/or as a model-predictive controller.

By taking account of the gain and the dead time, an oscillation of the actual value around the target value can be minimized, so that actuator 2 has to be controlled correspondingly less frequently and less significantly.

The practice of the invention is not limited to the preferred exemplary embodiments set forth above. Instead, a number of variants may be contemplated which make use of the solution shown even in case of basically different embodiments.

1. A method for controlling a fuel-air mixture of a system which is in particular a gas boiler comprising:
the system has a mixer for mixing a fuel with air to form the fuel-air mixture, an actuator is arranged upstream of the mixer in the flow direction of the fuel and is driven by a manipulated variable, for controlling a fuel mass flow, and a differential pressure sensor for recording a differential pressure between a pressure p2 of the fuel upstream of the mixer and downstream of the actuator relative to a reference pressure in the flow direction of the air upstream of the mixer as an actual value, and
recording the actual value by the differential pressure sensor changes with a change in position of the actuator after a dead time and with a gain factor which depends on the manipulated variable causing the change, so that the system behavior is describable by means of the dead time and the gain factor;
determining the manipulated variable for driving the actuator is determined in a first method phase for identification of the system behavior using a standard controller, in order to adjust the actual value on average to a target value, the manipulated variable and the actual value may oscillate due to each of the dead time and the gain factor with an amplitude and a frequency around the target value;
recording a profile of the actual value and a profile of the manipulated variable during the first method phase for identification of the system behavior are recorded, and from these the gain factor depending on the manipulated variable and the dead time are determined;
determining the manipulated variable after the determination of the dead time and the gain factor in a second method phase for model-predictive adaptive control of the system using a model-based controller which in particular has a Smith predictor and which takes account of the gain factor and the dead time, in order to adjust the actual value to the target value, so that in the second method phase the manipulated variable has to be altered less frequently and less significantly by comparison with the first method phase.

2. The method according to claim 1,
determining, during the second method phase, a deviation of the actual value from the target value, and
if the deviation and/or an average value of the deviation exceeds a predetermined limit value, the dead time and the gain factor in accordance with the first method phase.

3. The method according to claim 1,
recording, during the second method phase, a profile of the manipulated variable and determining a number and level of manipulated variable changes, and
newly determining the dead time and the gain factor in accordance with the first method phase, if the number and/or the level of the manipulated variable changes exceed a respective predetermined limit value.

4. The method according to claim 1,
wherein the method remains in the first method phase for a predetermined time before changing to the second method phase.

5. The method according to claim 1 and determining,
the dead time from a delay between a change in the manipulated variable and a change in the actual value caused by the change in the manipulated variable.

6. The method according to claim 1 and determining,
the gain factor and/or the dead time by a Wiener filter, the Wiener filter is configured to determine the gain factor and/or the dead time using the manipulated variable and the actual value.

7. The method according to claim 1,
wherein the model-based controller comprises the Smith predictor and a standard controller, and
determining the manipulated variable by superimposing the Smith predictor with the standard controller, so that the dead time is compensated by the Smith predictor and the gain factor is compensated by the standard controller.

8. A system, in particular a gas boiler, comprising;
mixer for mixing a fuel with air to form the fuel-air mixture, an actuator arranged upstream of the mixer in the flow direction of the fuel and is driven by a manipulated variable for controlling a fuel mass flow, and a differential pressure sensor for recording a differential pressure between a pressure p2 of the fuel upstream of the mixer and downstream of the actuator relative to a reference pressure in the flow direction of the air upstream of the mixer as an actual value,
and the system further comprises a control signally connected to the actuator and the differential pressure sensor, which is configured to carry out a method according to claim 1.

9. The system according to claim 8,
wherein the actuator is a control valve with a stepper motor, where the mass flow through the control valve is adjustable, and
the manipulated variable is a number of steps of the stepper motor.

10. The system according to claim 8,
wherein the target value is a predetermined value, in particular 0 Pa.
